(19) United States
(12) Patent Application Publication
(10) Pub. No.: US 2007/0252335 A1
(43) Pub. Date: Nov. 1, 2007

(54) Memory seal assembly for an internal combustion engine

(76) Inventor: Bryan S. Breen, Commerce Township, MI (US)

Correspondence Address: MARSHALL & MELHORN, LLC, FOUR SEAGATE, 8TH FLOOR, TOLEDO, OH, 43804, US

(21) Appl. No.: 11/823,599

(22) Filed: Jun. 28, 2007

Related U.S. Application Data
(63) Continuation-in-part of application No. 11/079,758, filed on Mar. 14, 2005.

(51) Int. Cl. F02F 11/00

(52) U.S. Cl. 277/313

(57) ABSTRACT

A seal assembly that includes a first mating component, a second mating component, and a gasket having a predetermined shape that is positioned between the first and second mating components and subjected to compression load. The gasket is constructed out of a memory material, such as a nickel titanium alloy. Upon application of heat from a heat source, gasket is urged to the original predetermined shape from the compressed configuration, thereby applying a desired force against the first and second mating components.

### RELATED APPLICATIONS

The present application is a continuation-in-part application of U.S. patent application Ser. No. 11/079,758 filed on Mar. 14, 2005 which is incorporated by reference in its entirety.

### FIELD OF THE INVENTION

The present invention relates generally to sealing assemblies, and more particularly to a sealing assembly having a resilient body for sealing components of internal combustion engines, wherein the sealing assembly is capable of returning to its original shape.

### BACKGROUND OF THE INVENTION

The use of gaskets in internal combustion engines to seal mating surfaces therein is commonly known. For example, gaskets are typically used to seal the interface between the cylinder head and the engine block, as well as between the cylinder head and the exhaust manifold. These gaskets help to prevent the escape of gases and liquids that circulate throughout the engine and to maintain adequate levels of compression during engine operation. However, although gaskets have been proven to be effective in preventing the escape of gases and liquids, they have several disadvantages.

One disadvantage of conventional gaskets includes their vulnerability to structural damage that frequently occurs during shipping, installation or handling of the gasket. For example, during installation, the gasket is subject to varying levels of compression that frequently cause damage to the gasket, which leads to premature gasket failure. As a result of that damage, the gasket is less effective in preventing the escape of gases and liquids from the engine. This results in decreased efficiency in engine performance and increased emission of gases that are harmful to the environment.

A second disadvantage of conventional gaskets arises from non-uniform loading across the gasket surface when installed. Accordingly, those areas having relatively reduced loading are a source of premature gasket failure. Therefore, as stated above, gases and liquids that circulate within the engine are allowed to escape.

In view of the foregoing disadvantages, designers have developed several improved gaskets. In particular, designers have developed a spring-energized gasket that includes a superalloy. When such a gasket is installed within the engine (e.g., between the cylinder head and engine block), the spring properties of the gasket enable it to expand within the engine block, thereby forming a seal between the cylinder head and engine block while the engine is in operation.

Although these improved gaskets have been proven to be effective in certain regards, they also have disadvantages. One such disadvantage is their inability to maintain an adequate seal in the event the gaskets are damaged during shipping, installation or handling. For example, although the spring-energized and expandable graphite gaskets are capable of expanding to create an improved seal, they are incapable of maintaining such a seal in the event of gasket damage. Consequently, even these so-called improved gaskets are subjected to premature failure when damaged or deformed. Further, automotive gaskets, for example, are subject to extreme variations in temperature. The foregoing spring-energized and graphite gaskets have a tendency to be affected by these extreme variations, which also leads to insufficient gasket performance.

Another type of gasket is described in JP 63-172064 which provides for a metal gasket utilizing a shape memory alloy. The device described therein however suffers from the disadvantage of remaining flat without beads or embossments until heat is applied. As such, the device is entirely ineffective to function as a sealing gasket unless heat is applied. Since gaskets in engines must seal while the engine is not operating, in the time between when the engine is turned over and when heat beings to build and while the engine operating, a gasket failing to have a sealing bead when there is little or no heat is unworkable. The device described therein also suffers from only being responsive to engine heat.

The embodiments described below were developed in light of these and other disadvantages of the existing gaskets.

### SUMMARY OF THE INVENTION

A seal assembly for use with an internal combustion engine is disclosed. The seal assembly includes a first mating component, a second mating component, and a gasket having a predetermined shape that is positioned between the first and second mating components. When positioned between the first and second components, the gasket is subjected to a compression load. The gasket is constructed out of a memory material, such as a nickel titanium alloy. Upon application of heat from a heat source, gasket is urged to the original predetermined shape from the compressed configuration, thereby applying a desired force against the first and second mating components. The heat source may be the heat from an operating combustion engine, or application of heat from an electrical current.

In one embodiment, the gasket is a wound exhaust manifold gasket. In another embodiment, the gasket is a cylinder head gasket having at least one layer.

### BRIEF DESCRIPTION OF THE DRAWINGS

These and other features and advantages of the invention will be apparent from the following detailed description and the appended claims, taken in conjunction with the accompanying drawings, in which:

FIG. 1 is an exploded perspective view of a cylinder head assembly having a head gasket according to an embodiment of the present invention;

FIG. 2 is a cross-sectional view of a cylinder head assembly having the head gasket of FIG. 1 and an exhaust manifold gasket disposed between the cylinder head and the exhaust manifold according to an embodiment of the present invention;

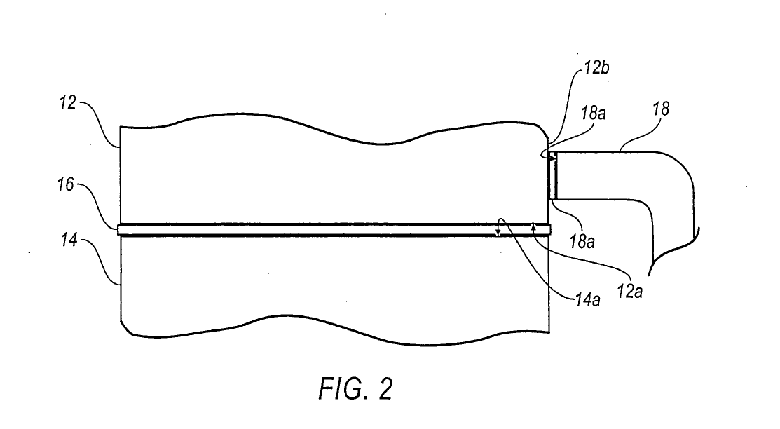

FIG. 3 is a cross-sectional view of one embodiment of a gasket of the present invention;

FIG. 4 is a plan view of an embodiment of a gasket of the present invention; and

FIG. 5 is a partial schematic side view of a multi-layer gasket of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

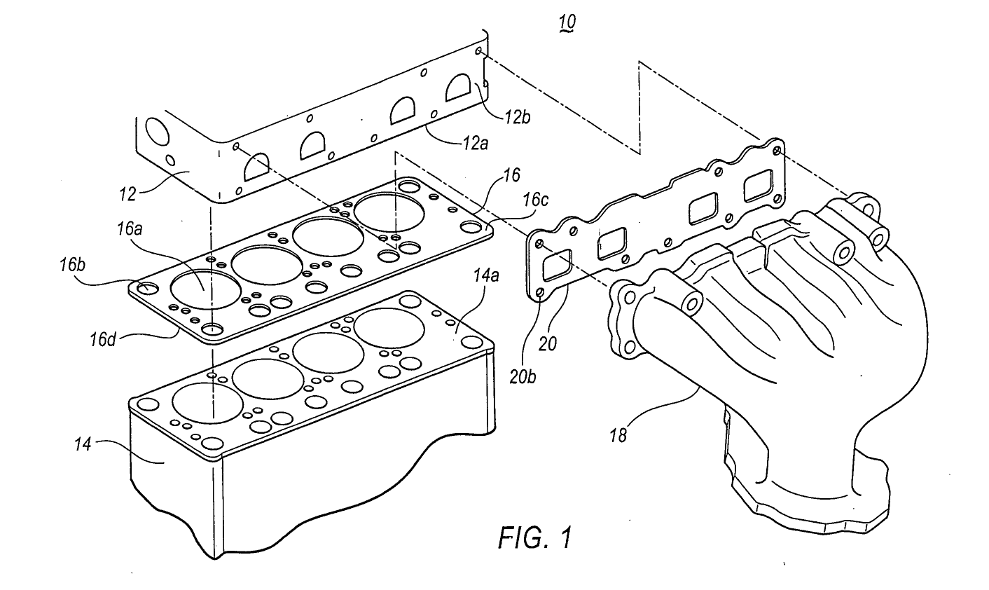

The embodiments described herein provide an improved sealing assembly for assuring that appropriate sealing exists within an engine in a manner that is both efficient with respect to manufacturing as well as in a manner designed to avoid premature failure of cylinder head and exhaust manifold gaskets. Referring initially to FIG. 1, a cylinder head assembly 10 is shown. Cylinder head assembly 10 includes a cylinder head 12, an engine block 14 and an exhaust manifold 18. Disposed between cylinder head 12 and engine block 14 is a head gasket 16. Head gasket 16 prevents the escape of gases and liquids from cylinder head assembly 10 and enables the proper compression of gases within cylinder head assembly 10 during engine operation.

Cylinder head 12 includes a cylinder head mating surface 12a that mates with a first surface 16c of head gasket 16. Engine block 14 has an engine block mating surface 14a. Engine block mating surface 14 a mates with a second surface 16d of head gasket 16.

Exhaust manifold 18 is connected to cylinder head 12 at cylinder head mating surface 12b. The connection between exhaust manifold 18 and cylinder head 12 is sealed by an exhaust manifold gasket 20. Exhaust manifold gasket 20 prevents exhaust leakage out of the connection and ensures that all exhaust gas will properly flow through a catalytic converter (not shown) for treatment.

In one embodiment, head gasket 16 is a multilayer gasket comprising several layers. As shown, gaskets 16 and 20 are formed with multiple apertures. In particular, and as shown in FIG. 1, head gasket 16 includes at least one bolt hole aperture 16b and several cylinder bore apertures 16a. Exhaust manifold gasket 20 similarly includes at least on bolt hole aperture 20 that aligns with bolt holes formed on exhaust manifold 18. Gaskets 16 and 20 also include multiple un-numbered apertures for coolant and bypass gases, as will be appreciated by those skilled in the art.

In accordance with one aspect of the invention, gaskets 16 and 20 are comprised of a nickel titanium steel alloy material such as Nitinol. All of the gasket 16, 20 may be constructed of the nickel titanium steel alloy, or just selected portions of it, such as embossments 30 (described below), may be constructed of the material. If the gasket 16, 20 is not entirely constructed of the material, additional suitable materials comprise 301SS, NiZn steel, 409SS, 201SS and 304SS materials.

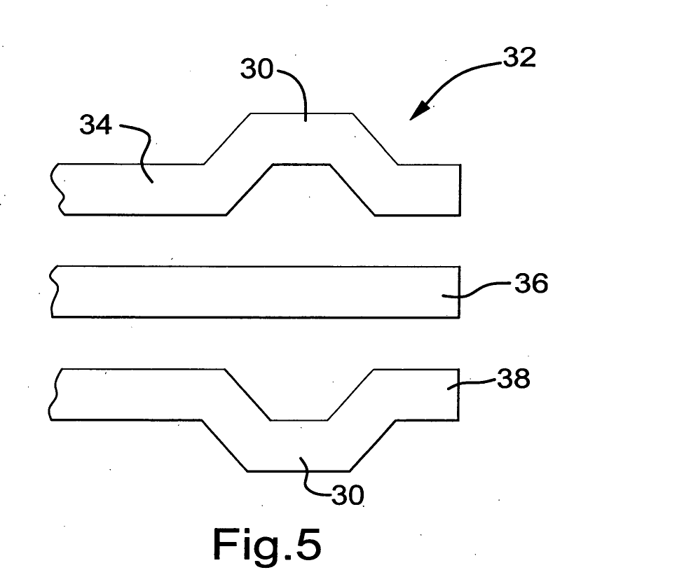

As shown in FIG. 5, the gasket 16, 20 may be a multi-layer gasket 32 including an upper layer 34, an intermediate layer 36 and a lower layer 38 formed of one or more of the foregoing materials. Gasket 32 may have a pre-formed embossment, or beads, 30 in one or more of the layers 34, 36, 38. In other embodiments, gasket 16, 20 may include additional layers, i.e., further intermediate layers sandwiched between the upper and lower layers. Gasket 16, 20 may also be a single gasket layer.

Nickel titanium steel alloy materials are given a memory shape upon formation through methods known to those familiar with the art. Once given a memory shape, if this material is subsequently deformed, the application of sufficient heat from a heat source such as an operating engine or an electric current will cause the material to return to its original memory shape or configuration. Accordingly, even in the event that gasket 16, 20 and/or embossments 30 become damaged or deformed during shipping, installation or handling, the application of naturally created heat from the engine or heat generated by an electric current from a current source will cause gasket 16, 20 and/or embossments 30 to return to their original design shape or configuration. Accordingly, gaskets. 16, 20 and/or embossments 30 are capable of consistently applying a desired spring force to the mating sealing surfaces in the engine.

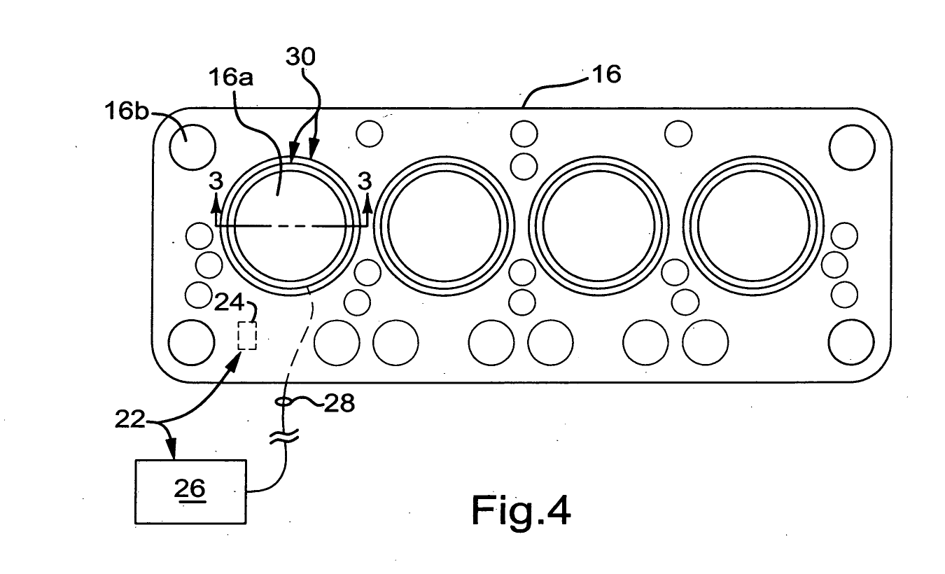

As noted above, gasket 16, 20 may have or it may be attached to an electrical current source 22, as shown in FIG. 4, so that application of the electric current causes the gasket 16, 20 to be heated and return to the memory shape. The electric current may come from one or more imbedded power supplies 24, a direct connection with a battery 26 via wires 28, or from any other source appropriate for the application. FIG. 4 depicts both an embedded power supply 24 and direct connection with a battery 26 via wires 28. It can be appreciated that one or both of these can be used to provide sufficient heat to the gasket 16, 20 and/or embossments 30.

To manufacture a gasket in accordance with the present invention, first, a suitable memory material is provided, such as nickel titanium alloy. The material is then formed into a predetermined and desired shape. For example, head gasket 16 may be formed with embossments 30 around cylinder bores 16a or the gasket 16 may be formed with an overall desired shape.

The entire gasket 16 may be constructed of the memory material or just the embossments 30. Embossments 30 of any number and/or shape may be utilized. The embossments 30 may rise above the first surface 16c of the gasket 16, 20 and/or extend below a second surface 16d of the gasket 16, 20, such as via one or more undulations on either or both surfaces 16c, 16d. Preferably, the embossments 30 are in this condition at least prior to installation so that they may function upon installation, barring any damage during transport or installation.

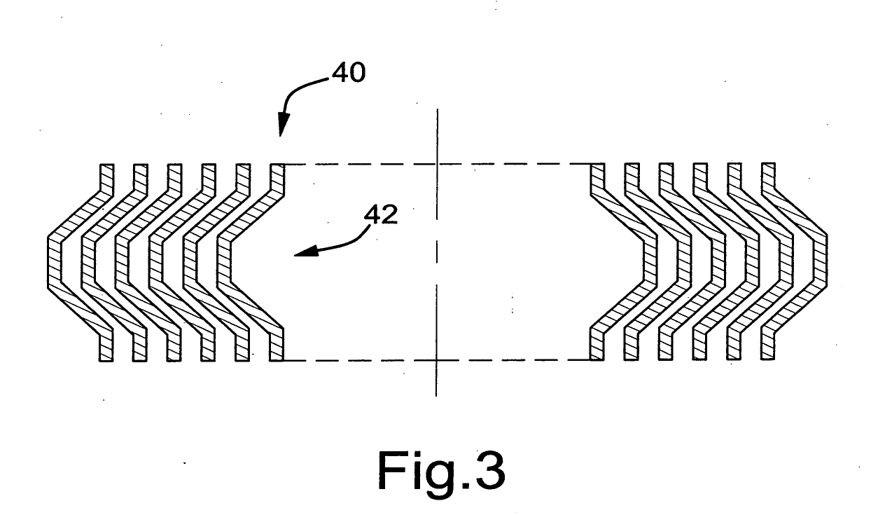

In yet another embodiment, roll stock of a memory material is provided with one or more beads located at the desired location in the stock. The stock is then rolled, turned and/or formed into a wound, or spiral wound, gasket 40, as shown in FIG. 3. It can be appreciated gasket 40 may be such a cylinder head gasket 16 or an exhaust manifold gasket 20.

In the embodiment of the gasket 40 depicted in FIG. 3, a generally V-shape 42 is provided to offer resilience to compressive forces acting on the gasket 40. Note that while a V-shape 42 is disclosed, the present invention is not limited to V-shapes 42.

When installed, a gasket 16, 20 made in accordance with the present invention, will function as in a typical fashion to seal around the openings formed in the mating surfaces. That is, the gasket 16, 20 and/or embossments 30 are compressed between the mating surfaces. However, because the memory material, and in particular, nickel titanium alloy, reacts to heat, when heat is applied to the gasket 16, 20, the gasket and/or embossments 30 will be automatically urged to return to their original design and shape, while consistently applying the desired spring force to the mating sealing surfaces. Thus, if the gasket 16, 20 becomes deformed in some manner, such as by way of example, from being compressed unevenly between head 12 and block 14, a predetermined amount of heat will automatically return the gasket 16, 20 to its original predetermined shape to ensure it continues to function properly.

In one embodiment, the gasket 16, 20 may be heated to approximately 900 degrees C. (1652 degrees F.) to return the gasket 16, 20 to its original shape. Naturally created heat, such as the heat from an operating combustion engine, or the application of an electrical current may be used to apply sufficient heat to cause the gasket 16, 20 to return to its original memory shape or design.

As described in the above, the embodiments set forth herein are capable of maintaining an improved seal between various mating surfaces of an internal combustion engine. Furthermore, even in the event of gasket shape deformation or gasket damage, gaskets 16 and 20 are capable of maintaining a tight seal between mating surfaces by consistently applying a sufficient force to the mating surfaces of the internal combustion engine in response to the application of heat or current.

Various other modifications to the present invention may occur to those skilled in the art to which the present invention pertains. Other modifications not explicitly mentioned herein are also possible and within the scope of the present invention. For example, the foregoing description refers to gaskets for internal combustion engines. However, as will be recognized by one of ordinary skill in the art, the present invention may be utilized in any high pressure, high temperature environment requiring a tight seal. It is the following claims, including all equivalents, which define the scope of the present invention.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A seal assembly in an internal combustion engine comprising:
a first mating component having a first plurality of apertures formed therein, said first mating component being a cylinder head of an internal combustion engine;
a second mating component having a second plurality of apertures formed therein, said second plurality of apertures aligning with and corresponding to said first plurality of apertures, said second mating component being one of an engine block and an exhaust manifold;
a gasket having a predetermined shape and further including a third plurality of apertures that correspond to said first and second plurality of apertures, said entire gasket being constructed of a nickel titanium steel alloy;
wherein said gasket is disposed between said first mating component and said second mating component such that said first, second and third plurality of apertures are aligned with one another, and wherein said gasket is subjected to a compression load, whereby said gasket is deformed from its original predetermined shape;
and wherein said gasket is urged to return to its said original predetermined shape and apply a force against said first and second mating components when subjected to heat from a heat source.

2. An assembly according to claim 1, wherein said gasket is a wound exhaust manifold gasket.

3. An assembly according to claim 1, wherein said gasket is a cylinder head gasket.

4. An assembly according to claim 3, wherein said gasket includes a plurality of layers.

5. An assembly according to claim 1, wherein said heat source is an operating internal combustion engine.

6. An assembly according to claim 1, wherein said heat source is an electric current.

7. An assembly according to claim 1, wherein said heat source generates heat that is at least about 900 degrees C. (1652 degrees F.).

8. An assembly according to claim 1, wherein said original predetermined shape includes embossments formed on at least one surface of said nickel titanium alloy gasket.

9. A seal assembly for an internal combustion engine, comprising:
a first mating component having at least one first aperture formed therein, said first mating component being a cylinder head of an internal combustion engine;
a second mating component having at least one second aperture formed therein, said second aperture aligning with and corresponding to said first aperture, said second mating component being one of an engine block and an exhaust manifold;
a gasket comprising at least one third aperture that corresponds to said first and second apertures, said gasket having at least one preformed upstanding embossment prior to installation in said components, said embossment constructed of a nickel titanium steel alloy;
wherein said gasket is disposed between said first mating component and said second mating component such that said first, second and third apertures are aligned with one another so that said gasket and said at least one upstanding embossment are subjected to a compression load causing at least said at least one embossment to be deformed from its original shape;
wherein said at least one embossment is urged to return to its original predetermined shape and apply a force against said first and second mating components via heat of at least approximately 900 degrees C. (1652 degrees F.) from an internal combustion engine.

10. An assembly according to claim 9, wherein said gasket is a cylinder head gasket.

11. An assembly according to claim 9, wherein said gasket includes a plurality of layers.

12. An assembly according to claim 9, wherein said gasket is a wound exhaust manifold gasket.

13. A seal assembly in an internal combustion engine, comprising:
a first mating component having at least one first aperture formed therein, said first mating component being a cylinder head of an internal combustion engine;
a second mating component having at least one second aperture formed therein, said second aperture aligning with and corresponding to said first aperture, said second mating component being one of an engine block and an exhaust manifold;
a gasket having a predetermined shape and further including at least one third aperture that corresponds to said first and second apertures, said gasket being constructed of a nickel titanium steel alloy;
wherein said gasket is disposed between said first mating component and said second mating component such that said first, second and third apertures are aligned with one another and such that said gasket is subjected to a compression load so that said gasket is deformed from its original predetermined shape;
wherein said gasket is urged to return to its original predetermined shape and apply a force against said first and second mating components via heat from an electric current.

14. An assembly according to claim 13, wherein said electric current is provided from a battery.

15. An assembly according to claim 13, wherein said original predetermined shape includes embossments formed on at least one surface of said gasket.

16. An assembly according to claim 13, wherein said electric current is provided from a source within said gasket.

17. An assembly according to claim 15, wherein said embossments are constructed of nickel titanium steel alloy.

18. An assembly according to claim 13, wherein said gasket is entirely constructed of nickel titanium steel alloy.
